(19) United States
(12) Patent Application Publication
(10) Pub. No.: US 2026/0037397 A1
(43) Pub. Date: Feb. 5, 2026

(54) FAILOVER AND SYNCHRONIZATION MANAGEMENT FOR DATABASES

(71) Applicant: Dell Products L.P., Round Rock, TX (US)

(72) Inventors: Pratheek Veluswamy, Bangalore (IN); Bijan Kumar Mohanty, Austin, TX (US); Hung Dinh, Austin, TX (US); Vasanth K. Ramu, Bangalore (IN)

(21) Appl. No.: 18/794,519

(22) Filed: Aug. 5, 2024

(51) Int. Cl. G06F 11/20; G06F 11/34; G06F 16/27; H04L 67/1031

(52) U.S. Cl. CPC G06F 11/2025; G06F 11/3409; G06F 16/27; H04L 67/1031

(57) ABSTRACT

A method comprises analyzing metrics corresponding to operation of a first node in a first data center using at least one machine learning algorithm, predicting, based at least in part on the analyzing of the metrics, whether the operation of the first node is anomalous, designating the first node as being in an anomalous state responsive to predicting that the operation of the first node is anomalous, and causing routing of one or more database transactions to a second node in a second data center instead of the first node in response to the anomalous state designation.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to failover and synchronization management for databases.

### BACKGROUND

Many applications rely on data stored in databases always being readily available and serviceable to the application. Databases built for high availability (HA) may provide fault tolerance within a single data center. However, critical applications need protection that ensures availability when a data center becomes unavailable. With conventional approaches, disaster recovery (DR) options may offer protection against large scale events and/or outages that can affect a data center. However, current techniques for DR, which are reactive to data center problems, can result in data loss and/or system instability. In addition, current DR approaches use large amounts of computing resources, resulting in high operational costs. Accordingly, there is a need to effectively enable DR while maintaining computing resources and operational costs at desirable levels.

### SUMMARY

Embodiments provide a database management platform in an information processing system.

For example, in one embodiment, a method comprises analyzing metrics corresponding to operation of a first node in a first data center using at least one machine learning algorithm, predicting, based at least in part on the analyzing of the metrics, whether the operation of the first node is anomalous, designating the first node as being in an anomalous state responsive to predicting that the operation of the first node is anomalous, and causing routing of one or more database transactions to a second node in a second data center instead of the first node in response to the anomalous state designation.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a database management platform in an illustrative embodiment.

FIG. 2 depicts a stretched cluster architecture for multiple data centers in an illustrative embodiment.

FIG. 3 depicts a plurality of decision trees used in connection with a random forest classifier according to an illustrative embodiment.

FIG. 4 depicts an operational flow for replication class prediction in an illustrative embodiment.

FIG. 5 depicts example pseudocode for importation of libraries in an illustrative embodiment.

FIG. 6 depicts example pseudocode for generation of training data in an illustrative embodiment.

FIG. 7 depicts example pseudocode for encoding training data in an illustrative embodiment.

FIG. 8 depicts example pseudocode for splitting a dataset into training and testing components and for creating separate datasets for independent and dependent variables in an illustrative embodiment.

FIG. 9 depicts example pseudocode for training and computing accuracy of a random forest classifier in an illustrative embodiment.

FIG. 10 depicts an operational flow for node anomaly prediction in an illustrative embodiment.

FIG. 11 depicts a plot illustrating normal state parameter values and anomalous state parameter values in an illustrative embodiment.

FIG. 12A depicts a plot illustrating isolation of a normal state point in an illustrative embodiment.

FIG. 12B depicts a plot illustrating isolation of an anomalous state point in an illustrative embodiment.

FIG. 13 depicts example training data in an illustrative embodiment.

FIG. 14 depicts example pseudocode for importation of libraries in an illustrative embodiment.

FIG. 15 depicts example pseudocode for loading historical node metrics data into a data frame in an illustrative embodiment.

FIG. 16 depicts example pseudocode for training an isolation forest model in an illustrative embodiment.

FIG. 17 depicts example pseudocode for computing anomaly scores using a model predict function in an illustrative embodiment.

FIG. 18 depicts a process for failover management according to an illustrative embodiment.

FIGS. 19 and 20 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a user device receives messages without any significant time delay. Of course, it should be understood that depending on the particular temporal nature of the system in which an embodiment is implemented, other appropriate timescales that provide at least contemporaneous performance and output can be achieved.

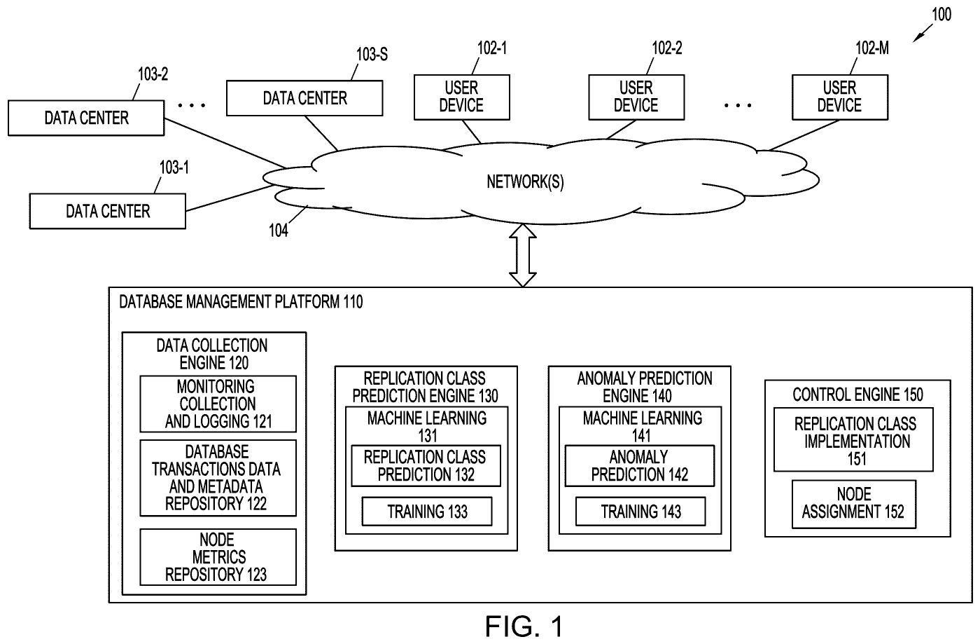

FIG. 1 shows an information processing system 100 configured in accordance with an illustrative embodiment. The information processing system 100 comprises user devices 102-1, 102-2, . . . 102-M (collectively “user devices 102”). The user devices 102 communicate over a network 104 with a database management platform 110. The variable M and other similar index variables herein such as K, L and S are assumed to be arbitrary positive integers greater than or equal to one.

The user devices 102 can comprise, for example, Internet of Things (IoT) devices, desktop, laptop or tablet computers, mobile telephones, or other types of processing devices capable of communicating with the database management platform 110 over the network 104. Such devices are examples of what are more generally referred to herein as “processing devices.” Some of these processing devices are also generally referred to herein as “computers.” The user devices 102 may also or alternately comprise virtualized computing resources, such as virtual machines (VMs), containers, etc. The user devices 102 in some embodiments comprise respective computers associated with a particular company, organization or other enterprise.

The terms “user”, “client”, “customer” or “administrator” herein are intended to be broadly construed so as to encompass numerous arrangements of human, hardware, software or firmware entities, as well as combinations of such entities. Database management services may be provided for users utilizing one or more machine learning models, although it is to be appreciated that other types of infrastructure arrangements could be used. At least a portion of the available services and functionalities provided by the database management platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the database management platform 110, as well as to support communication between the database management platform 110 and connected devices (e.g., user devices 102) and/or other related systems and devices not explicitly shown.

In some embodiments, one or more of the user devices 102 are assumed to be associated with repair technicians, system administrators, information technology (IT) managers, software developers, release management personnel or other authorized personnel configured to access and utilize the database management platform 110.

The information processing system 100 further includes data centers 103-1, 103-2, . . . 103-S (collectively “data centers 103”) connected to the user devices 102 and to the database management platform 110 via the network 104. The data centers 103 respectively comprise physical devices such as, for example, servers (e.g., modular servers, blade servers, server modules (blades), etc.), switches, chassis, etc., which are connected over one or more local networks and/or through direct wired connections. Two or more of the data centers 103 may be connected to each other via the network 104.

Multiple servers (also referred to herein as “nodes”) in a data center may respectively include all or portions of storage pools and comprise, for example, storage arrays and corresponding storage devices, and one or more aggregators. In illustrative embodiments, respective data centers 103 include a plurality of aggregators and a plurality of leaf nodes storing data corresponding to one or more databases. An aggregator is responsible for receiving query requests (e.g., structured query language (SQL) requests), retrieving data from one or more of the leaf nodes, aggregating the results and sending the response back to a client (e.g., via a user device 102). In illustrative embodiments, a leaf node stores a subset of data that is distributed across a cluster of leaf nodes. When queries run against this distributed data, they may rely on data from all of the leaf nodes in a data center 103. With some conventional approaches, if one of the leaf nodes in a data center is unavailable, then any query reading or writing to a given database can fail

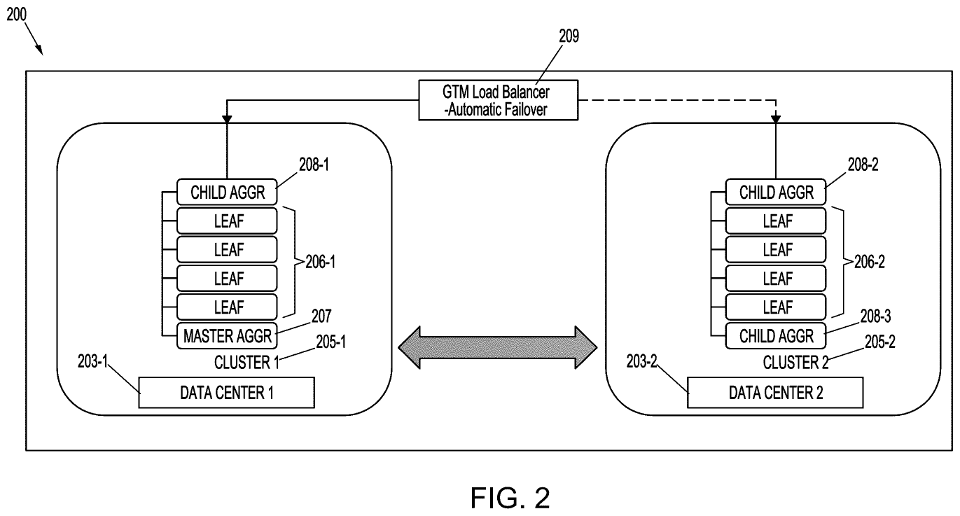

In a non-limiting illustrative embodiment, FIG. 2 depicts a stretched cluster architecture 200 for first data center 1 203-1 and second data center 2 203-2 (collectively “data centers 203”). The data centers 203 may be the same as or similar to the data centers 103. The first and second data centers 203-1 and 203-2 are in different locations from each other (e.g., different geographic areas) and are connected to each other by a network like network 104. In a non-limiting example, the network can be a wide area network (WAN). The different locations serve to minimize risk if one of the locations is compromised by an event such as, for example, loss of power, natural disaster, etc. As explained in more detail herein, the second data center 2 203-2 may include the same data and substantially the same architecture as the first data center 1 203-1, and can function as a seamless backup to the first data center 1 203-1 in the event of a predicted or actual issue with one or more of the nodes of the first data center 1 203-1.

The first and second data centers 203-1 and 203-2 respectively include a first cluster 1 205-1 and a second cluster 205-2 (collectively “clusters 205”). The first and second clusters 205-1 and 205-2 respectively include a first plurality of leaf nodes 206-1 and a second plurality of leaf nodes 206-2 (collectively “leaf nodes 206”). The first cluster 205-1 further includes a master aggregator (“master aggr”) 207 and a first child aggregator (“child aggr”) 208-1. The second cluster 205-2 further includes a second child aggregator (“child aggr”) 208-2 and a third child aggregator (“child aggr”) 208-3. The first, second and third child aggregators 208-1, 208-2 and 208-3 may collectively be referred to as “child aggregators 208.” Stretching the clusters 205 between separate data centers 203 advantageously provides HA and DR solutions.

In a non-limiting illustrative example, the clusters 205 are Elastic Sky Xᵢ (ESXᵢ) clusters. Additional aggregators (e.g., child aggregators 208) may be dynamically added at each of the data centers 203 depending on the number of leaf nodes 206. A designated ratio of the number of aggregators 207/208 to leaf nodes 206 can vary. In an illustrative embodiment, a global traffic manager (GTM) load balancer 209 is connected to the data centers 203 to implement automatic failover from one or more nodes of the first data center 1 203-1 to the second data center 2 203-2. In a non-limiting example, if failover is required from the first data center 1 203-1, the GTM load balancer 209 will transparently implement the failover for all the databases in the first data center 1 203-1 to the second data center 2 203-2 without manual intervention.

As noted above, critical applications need protection that ensures availability when a data center becomes unavailable, but current techniques for DR are reactive to data center problems and can result in data loss and/or system instability. The mechanism of replicating data across multiple nodes and switching from one or more primary nodes to one or more secondary nodes in the event of primary node failure is a fundamental strategy for ensuring HA and disaster recovery in distributed database systems, including in-memory databases and graph databases. However, the reactive approach of waiting for a primary node to fail before system switching to a secondary node has several disadvantages. Besides increased down time and user experience issues, there could be potential data integrity problems and data loss due to lack of data synchronization between primary and secondary nodes at the time of outages. There are also system stability issues, as reactive approaches of waiting until node failure can increase load on a system, which can have cascading effects on a system while recovering from an unexpected outage.

In effort to address these issues, the illustrative embodiments proactively and reactively provide for HA and DR of distributed database systems such as, for example, in-memory and graph databases. The embodiments advantageously provide stretched cluster architectures (e.g., stretched cluster architecture 200) including node clusters (e.g., clusters 205) that span across different data centers (e.g., data centers 203). In connection with the stretched cluster architectures, the embodiments use machine learning classification algorithms to predict appropriate replication techniques between the data centers. As an additional advantage, the illustrative embodiments provide a framework which predicts impending issues and/or outages in data center nodes using sophisticated machine learning-based anomaly detection algorithms. By implementing the smart detection of primary node failures before their occurrence, and switching to secondary nodes seamlessly, the framework of the illustrative embodiments enables automated self-healing for distributed database systems.

As noted herein above, the embodiments are applicable to in-memory and graph databases. In-memory databases offer significant performance advantages over traditional disk-based databases and can be used for caching, session management and real-time analytics. Some in-memory databases may offer a distributed SQL database that unifies transactions and analytics in a single platform to process high throughput and low latency operations when rapid access to data is crucial. In-memory databases utilize massive parallel processing and a distributed database architecture to facilitate the development of applications that require fast data processing and flexible scaling. A distributed database architecture may be built using multiple servers using, for example, aggregators and leaf nodes as discussed herein above.

In-memory databases used in connection with the illustrative embodiments can mirror data between two groups (e.g., two data centers in a stretched cluster architecture), and the mirrored data is separated on different leaf nodes, so that one group stores active data, and the other group stores a copy of the data. If a node storing active data becomes unavailable or is predicted to become unavailable, the in-memory database automatically enables the data copy to become the active data in order to solve availability issues.

Graph databases manage and analyze highly interconnected data, offering significant advantages over traditional relational databases for specific use cases. Graph databases are designed to represent complex relationships between data points efficiently, mirroring networks found in product configurations, social graphs, recommendation engines, fraud detection systems, etc., to allow for faster and more intuitive queries on complex relationships.

The database management platform 110 in the present embodiment is assumed to be accessible to the user devices 102 and data centers 103, and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the database management platform 110 includes a data collection engine 120, a replication class prediction engine 130, an anomaly prediction engine 140 and a control engine 150. The data collection engine 120 includes a monitoring, collection and logging layer 121, a database transactions data and metadata repository 122 and a node metrics repository 123. The replication class prediction engine 130 includes a machine learning layer 131 comprising replication class prediction and training layers 132 and 133. The anomaly prediction engine 140 includes a machine learning layer 141 comprising anomaly prediction and training layers 142 and 143. The control engine 150 includes a replication class implementation layer 151 and a node assignment layer 152.

The monitoring, collection and logging layer 121 of the data collection engine 120 collects operational metrics corresponding to the operation of data center nodes from the data centers 103. The parameters may be collected from the nodes (e.g., servers including aggregators and leaf nodes) and/or from applications used for monitoring operational metrics, such as, for example, Elasticsearch®, Logstash® and Kibana® (ELK), Splunk® and other monitoring tools. The operational metrics comprise, for example, central processing unit (CPU) utilization (%), memory utilization (%), disk utilization (%), network throughput (Gbps), query latency (ms), a number of processed queries per second (or other time unit) (QPS), a number of processed database transactions per second (or other time unit) (TPS), a cache hit rate (%) and an error rate (%). As explained in more detail herein below, the operational metrics are analyzed using machine learning techniques to predict whether nodes corresponding to the operational metrics are in a normal or anomalous state. In addition, collected historical operational metrics are used to train the machine learning models that are used to predict whether nodes corresponding to the operational metrics are in a normal or anomalous state.

In connection with determining how data should be replicated between data centers (e.g., data centers 103 or 203), the monitoring, collection and logging layer 121 of the data collection engine 120 collects data and/or metadata corresponding to database transactions being processed by one or more of the data centers 103. The data and the metadata identify at least one of database transaction type, a level of data criticality, a level of data urgency, database transaction frequency, a latency tolerance and a replication delay tolerance. In more detail, the transaction type refers to, for example, read, write, update and/or delete transactions. The level of data criticality refers to an importance or sensitivity of the data. For example, personally identifiable information (PII), order information, data requiring real-time analysis, delivery or actions, etc. may be considered more critical than other data. The level of data urgency corresponds to whether data must be processed or accessed in a short time-frame or whether delays would not affect an outcome. For example, transactions for marketing data or to store notifications may be considered non-urgent, while medical data, weather data, location data, or other data needed for swift or immediate action, may be considered urgent data. Database transaction frequency provides an indication of data access patterns. For example, some data may be more frequently or regularly accessed than other types of data. Latency tolerance refers to a level of tolerance for latency in connection with a given transaction. Similarly, replication delay tolerance refers to a level of tolerance for delays replicating the data to another node in connection with a given transaction. As explained in more detail herein below, the data transaction data and metadata is analyzed by a classification machine learning algorithm to determine a type of a mode of replication to use when replicating the data between nodes of data centers 103/203. In addition, collected historical data transaction data and metadata is used to train the classification machine learning algorithm to determine the type of a mode of replication to use when replicating the data between nodes of data centers 103/203.

The replication class prediction engine 130, more particularly, the replication class prediction layer 132 of the machine learning layer 131, analyzes data and/or metadata corresponding to one or more database transactions using one or more machine learning algorithms. In connection with the one or more database transactions, the replication class prediction layer 132 predicts, based at least in part on the analyzing, a class of replication to apply between a first cluster of nodes in a first data center (e.g., first plurality of leaf nodes 206-1 in the first data center 1 203-1) and a second cluster of nodes in a second data center (e.g., second plurality of leaf nodes 206-1 in the second data center 2 203-2).

For example, synchronous replication is suitable for environments where data consistency is critical. With synchronous replication, data is written to a primary location and simultaneously mirrored to a secondary location. The write transaction is considered successful once it has been confirmed by both sites. This method guarantees zero data loss (Recovery Point Objective (RPO) of zero), but can impact performance due to latency that is introduced by waiting for acknowledgments from the secondary location that writing the data at the secondary location was successful. Synchronous replication in in-memory and graph databases ensures that data is consistently replicated across multiple nodes or locations at the time of a transaction, providing a high level of data integrity and fault tolerance. This is achieved by writing data to the primary node and simultaneously sending it to one or more replica nodes. The transaction is considered complete when all nodes acknowledge the write operation. This method of replication guarantees that data on the secondary nodes is in sync with the data on the primary nodes, effectively eliminating data discrepancies that might occur due to issues such as, for example, network delays or node failures. While synchronous replication offers strong consistency and immediate recovery from node failures, it can introduce latency in the write process since the system must wait for the replica nodes to confirm the transaction. This trade-off may be critical in some high-performance environments utilizing in-memory and graph databases, where speed and real-time processing may have high importance.

Asynchronous replication may be suitable for some geographically dispersed data centers where network latency may significantly impact the ability to perform synchronous replication. Asynchronous replication does not require immediate acknowledgment from the secondary site for transactions to be considered complete at the primary site. As a result, performance impact is reduced, but at the expense of potentially losing some recent transactions if the primary site fails before data is replicated to the secondary site. In illustrative embodiments, a messaging and streaming platform such as, for example, Kafka® is leveraged to achieve asynchronous replication and prevent data loss. For example, in order to ensure against situations where data might not have been replicated at a secondary site before failure of a primary site, a change data capture (CDC) mechanism can be used to capture changes to a primary database and publish the changes to a Kafka® topic after compressing the data. The data can be compressed using, for example, Snappy or LZ4 compression algorithms. Kafka® consumers running in the secondary database data center can consume the compressed data and update the secondary database after de-compression is performed with the same compression algorithm that was used to perform the compression.

As can be understood, the characteristics of synchronous and asynchronous replication are different. Synchronous replication is more suitable where data consistency is critical (“strong consistency”) and asynchronous replication is more suitable where data consistency is less critical (“eventual consistency”). As used herein, “strong consistency” and “eventual consistency” refer to two types of consistency to describe how data is returned in response to a query. Strong consistency ensures that all nodes in a system see the same data at the same time, while eventual consistency allows for temporary inconsistencies before all nodes are eventually updated.

The replication class prediction layer 132 classifies database transactions into two replication classes (e.g., synchronous and asynchronous) and selects the appropriate replication approach to use based on the predicted class. For example, in an illustrative embodiment, based on the predicted class, in connection with replication from the first plurality of leaf nodes 206-1 to the second plurality of leaf nodes 206-2, synchronous or asynchronous replication will be used based on the predicted class. The replication class prediction layer 132 uses a machine learning based classifier to categorize database transactions based on the multi-dimensional features of database transactions described herein above (e.g., database transaction type, a level of data criticality, a level of data urgency, database transaction frequency, a latency tolerance and a replication delay tolerance).

Based on these features, a labeled dataset with specific class labels (e.g., asynchronous/eventual consistency or synchronous/strong consistency) based on historical transactions will be used by the training layer 133 as a dataset to train the machine learning-based classifier to predict the class of any new database transaction. The illustrative embodiments leverage a Random Forest classifier, which can provide excellent accuracy using a relatively small training dataset.

The Random Forest algorithm is used for prediction and recommendation because of its efficiency and accuracy of processing various sizes of data. The random forest algorithm uses bagging (bootstrap aggregating) to generate predictions; this includes using multiple classifiers (e.g., in parallel) each trained on different data samples and different features. This reduces the variance and the bias that results from using a single classifier. Final classification is achieved by aggregating the predictions that were made by the different classifiers.

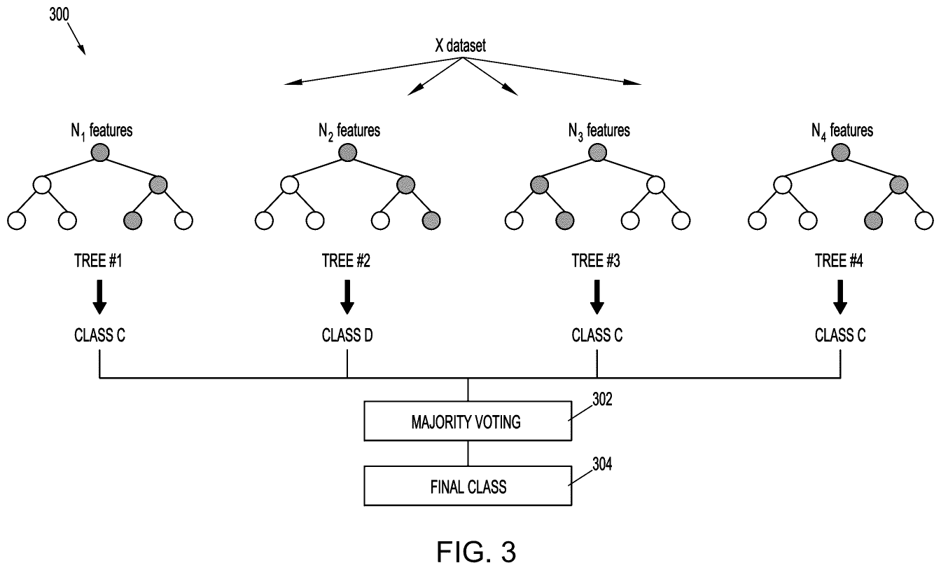

Referring to the random forest classifier diagram 300 in FIG. 3, the machine learning layer 131 constructs a plurality of decision trees (Tree #1, Tree #2, Tree #3 and Tree #4) using different features and different data samples, which reduces bias and variance as noted above. In the training process, the decision trees Tree #1, Tree #2, Tree #3 and Tree #4 are constructed using the training data, which comprises historical database transaction data and metadata. In the testing process, data (“X dataset” in FIG. 3) comprising, for example, a database transaction type, a level of data criticality, a level of data urgency, database transaction frequency, a latency tolerance and a replication delay tolerance, is inputted to the multiple decision trees (Tree #1, Tree #2, Tree #3 and Tree #4) to generate a predicted class (e.g., Class C or D) representing a mode of replication (asynchronous or synchronous) or consistency (eventual consistency or strong consistency). Based on the inputted data, each decision tree (Tree #1, Tree #2, Tree #3 and Tree #4) yields a class corresponding to a replication mode/consistency and the final prediction (final class 304) is determined by majority voting 302 (which class received the majority of votes). The multiple independent variables comprise the features of the X dataset as explained hereinabove, whereas the target variable (Y value) is the replication mode/consistency class predicted/recommended by the model. Random forest classification is based on the wisdom of a plurality of models. Instead of using just one model (e.g., decision tree) to make a prediction, a random forest technique uses multiple uncorrelated decision trees, which outperform the methodology when using single tree. The use of multiple decision trees minimizes errors, when compared with using a single decision tree. In this model, even if some trees might yield an incorrect result, the majority of decision trees will produce a correct result. Although four decision trees are shown, the embodiments are not necessarily limited to four decision trees, and more or less decision trees may be used.

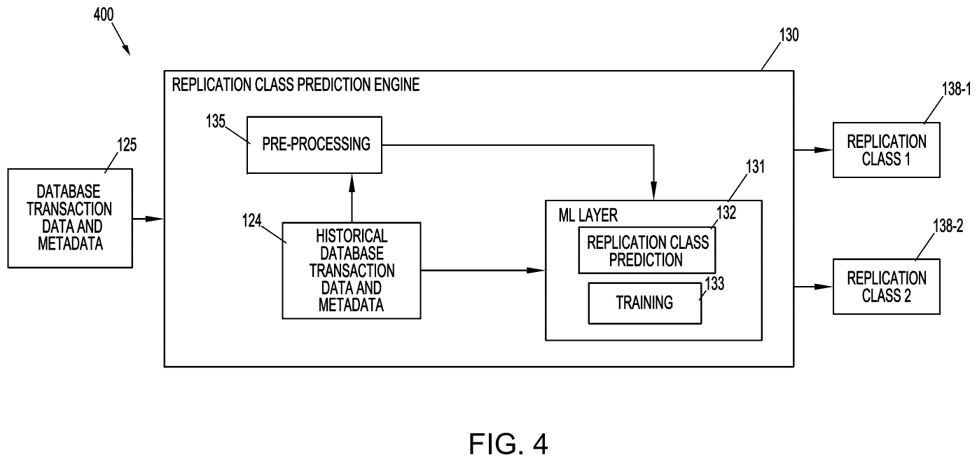

Referring to the operational flow 400 in FIG. 4, the replication class prediction engine 130 receives as input database transaction data and metadata 125. The database transaction data and metadata 125 identifies one or more features (e.g., features in X dataset) of the database transaction for which a replication class needs to be predicted. The replication class prediction engine 130 includes the machine learning (ML) layer 131, which leverages the decision tree-based, ensemble bagging algorithm as explained hereinabove and is trained with historical database transaction data and metadata 124 from the database transactions data and metadata repository 122 to accurately predict a replication class (e.g., replication class 1 138-1 or replication class 2 138-2). In FIG. 4, the replication class prediction engine 130 illustrates a pre-processing component 135, which processes the incoming database transaction data and metadata 125 and the historical database transaction data and metadata 124 for analysis by the ML layer 131. For example, the pre-processing component 135 removes any unwanted characters, punctuation, and stop words. In addition, in illustrative embodiments, the pre-processing component 135 performs data engineering and data pre-processing to identify the significance of each feature in a dataset so that less important data elements to the prediction are given less weight and/or are filtered. Additionally, as described in more detail herein below, the pre-processing component 135 prepares and encodes the data for analysis by the machine learning algorithms.

The predicted replication class 138-1 or 138-2 is used by the replication class implementation layer 151 of the control engine 150 to perform replication of data in nodes of one data center to nodes of another data center. For example, in the stretched cluster architecture 200 of FIG. 2, for a given database transaction, data in the first plurality of leaf nodes 206-1 of the first data center 1 203-1 is replicated to the second plurality of leaf nodes 206-2 of the second data center 2 203-2 using the replication type of the predicted replication class 138-1 or 138-2.

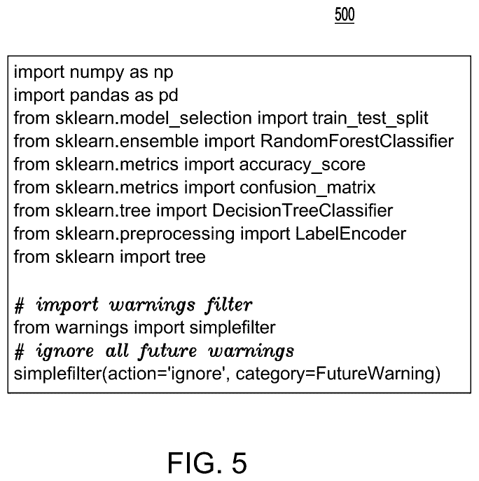

In connection with the operation of the replication class prediction engine 130, FIG. 5 depicts example pseudocode 500 for importation of libraries used to implement the replication class prediction engine 130. For example, Python, ScikitLearn, Pandas and Numpy libraries can be used. Illustrative embodiments implement classification using a Random Forest classifier to predict a replication class for database transaction.

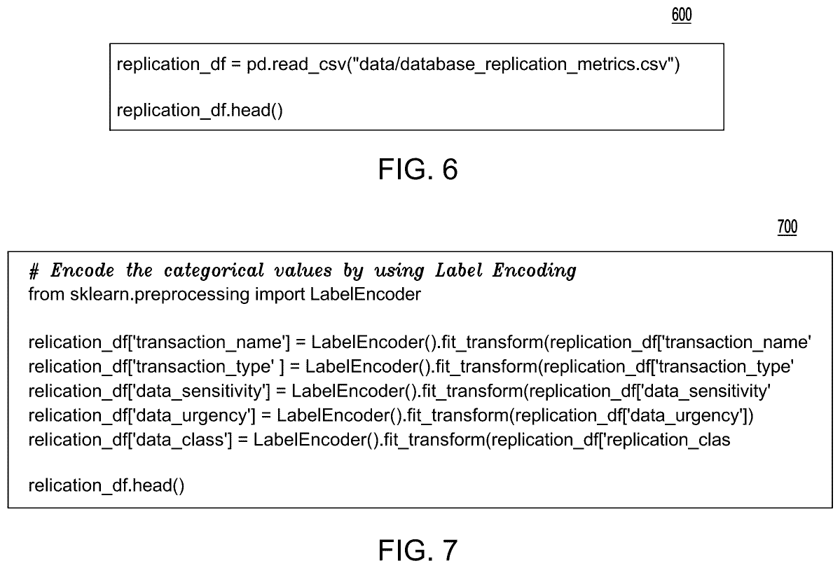

FIG. 6 depicts example pseudocode 600 for generation of training data. The example pseudocode 600 is for reading historical database transaction data and metadata (e.g., database replication metrics) into a Pandas data frame for building training data. A historical database replication metrics file including historical database transaction data and/or metadata for multiple database transactions is generated as a CSV file and the data is read to a Pandas data frame.

FIG. 7 depicts example pseudocode 700 for encoding training data. Referring back to the pre-processing component 135 in FIG. 4, since machine learning works with numbers, categorical and textual attributes like transaction names, transaction types, data sensitivity (or criticality), data urgency, replication class, etc. must be encoded before being used as training data. In one or more embodiments, this can be achieved by leveraging a LabelEncoder function of ScikitLearn library as shown in the pseudocode 700 in FIG. 7.

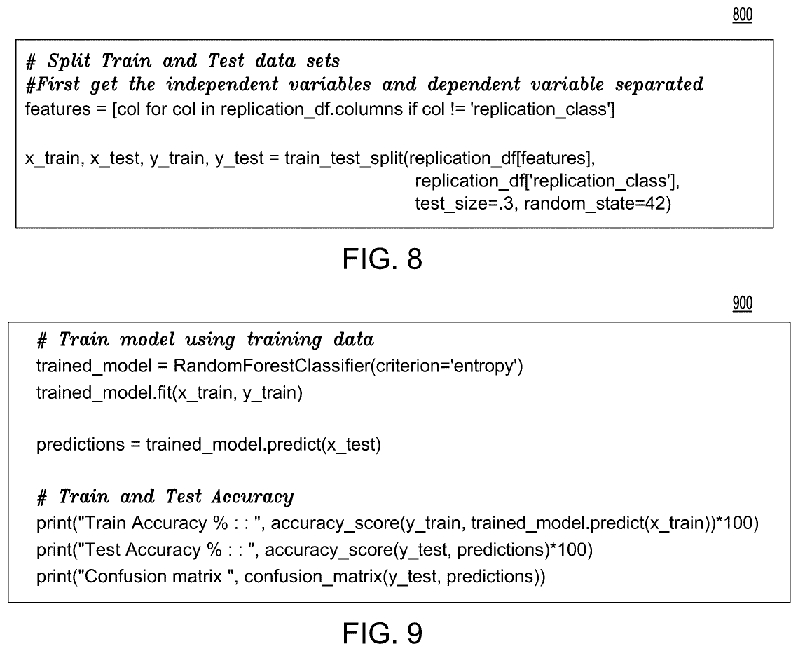

According to illustrative embodiments, the encoded training dataset is split into training and testing datasets, separate datasets are created for independent variables and dependent variables. Some embodiments use a train_test_split function of an sklearn library to split the data into training and testing sets. The training set is used for training the machine learning model(s) while the test set is used for testing/validating and computing accuracy score(s) of the model(s). In some embodiments, a training set will contain 70% of the observations, while a testing set will contain 30% of the observations. The function also separates the target variable (y) and the independent variables (X). FIG. 8 depicts example pseudocode 800 for splitting a dataset into training and testing components and for creating separate datasets for independent (X) and target (y) variables.

FIG. 9 depicts example pseudocode 900 for training and computing accuracy of a random forest classifier. The Random Forest classifier is created using sklearn library with the criterion hyperparameter as “entropy”. The model is trained using the training data sets with both independent variables (X_train) and target variable (Y_train). Once trained, the model is asked to predict by passing the test data of independent variable (X_test). The predictions, accuracy and confusion matrix are printed. Hyperparameter tuning can be done to improve the accuracy of the model.

As a proactive approach, the illustrative embodiments leverage anomaly detection techniques to predict an upcoming outage to or unavailability of a node of a database with a high degree of accuracy. Once an upcoming outage or unavailability is predicted, using the node assignment layer 152 of the control engine 150, the database management platform 110 is configured to alert an operational team via one or more user devices 102 to intervene and take necessary mitigating actions to prevent an outage or handle the issue in such a manner to prevent any negative impact to the over-all efficiency of the database. Alternatively, the node assignment layer 152 automatically causes transfer of database transactions to a backup/secondary node to the node that has been predicted to fail. For example, if one or more of the first plurality of leaf nodes 206-1 in the first data center 1 203-1 are determined to be in an anomalous state and are predicted to fail, the node assignment layer 152 invokes the GTM load balancer 209 to cause one or more of the second plurality of leaf nodes 206-2 to be used in place of the affect ones of the first plurality of leaf nodes 206-1. In some cases, database transactions will be transferred over to the second data center 2 203-2 in its entirety to operate in place of the first data center 1 203-1.

The anomaly prediction engine 140, more particularly, the anomaly prediction layer 142 of the machine learning layer 141, analyzes metrics corresponding to operation of a first node in a first data center using one or more machine learning algorithms. As explained herein above, the monitoring, collection and logging layer 121 of the data collection engine 120 collects operational metrics corresponding to the operation of data center nodes from the data centers 103. The operational metrics comprise, for example, CPU utilization (%), memory utilization (%), disk utilization (%), network throughput (Gbps), query latency (ms), a number of processed queries per second (or other time unit) (QPS), a number of processed database transactions per second (or other time unit) (TPS), a cache hit rate (%) and an error rate (%). The anomaly prediction layer 142 predicts, based at least in part on the analyzing of the metrics, whether the operation of the first node is anomalous, and the first node is designated as being in an anomalous state responsive to predicting that the operation of the first node is anomalous. The node assignment layer 152 causes routing one or more database transactions to a second node in a second data center instead of the first node in response to the anomalous state designation.

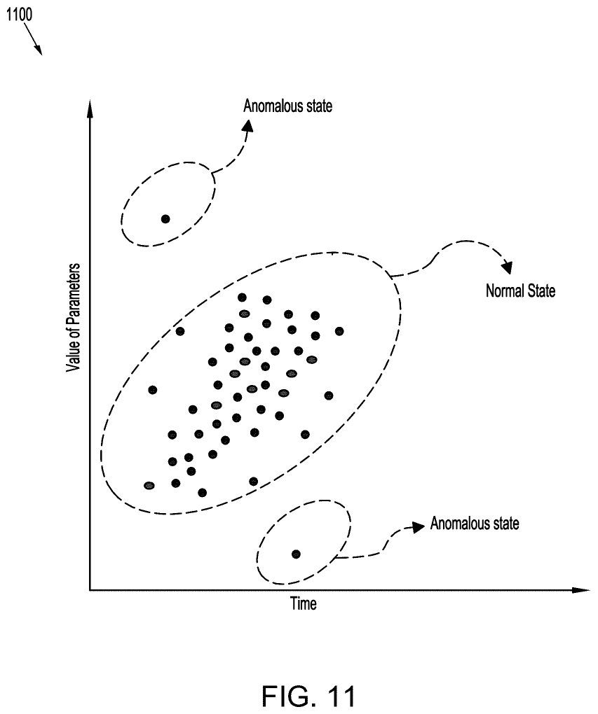

For example, under normal operating conditions, a given node may have specific CPU, memory and/or disk utilization, network throughput, query latency, QPS, TPS, cache hit rate and/or error rate. During issues, outages and/or overloaded situations, the values of these parameters may vary, and may be considered as outliers or anomalies by the anomaly prediction layer 142. The anomaly prediction layer 142 analyzes metrics collected by the monitoring, collection and logging layer 121 to identify abnormal patterns in the data to determine outliers. For example, based on historical metrics data, the training layer 143 trains the machine learning model to identify what constitutes normal operational node metrics. Deviations from normal operations found in, for example, real-time node metrics, are considered anomalies by the anomaly prediction layer 142. For example, FIG. 11 depicts a plot 1100 illustrating normal state parameter values and anomalous state parameter values, where the anomalous state parameter values are outliers from the normal state parameter values.

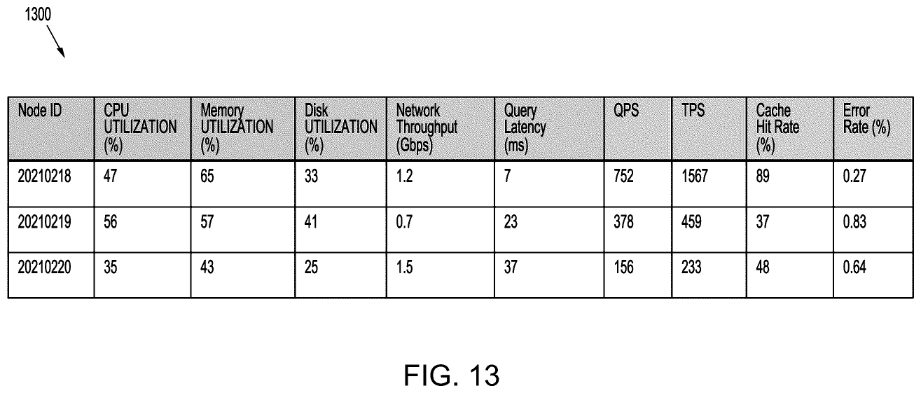

FIG. 13 depicts example training data in an illustrative embodiment. As can be seen in the table 1300, the training data identifies a node ID, and the following features associated with each node ID: CPU, memory and disk utilization, network throughput, query latency, QPS, TPS, cache hit rate and error rate. The data shown in the table 1300 is a non-limiting example of the attributes of training data, and the embodiments are not necessarily limited to the depicted attributes.

Anomaly detection or outlier detection is a mechanism to identify situations that are not considered normal based on the past observation of the properties being considered. Excessive utilization of resources, excessive generation of errors, etc. may be considered anomalies and may be indications of an upcoming outage. Not all anomaly events are necessarily precursors for outages, but they may trigger alerts for automated and/or manual analysis of node operation to prevent an outage. In such a case, an anomalous state designation by the anomaly prediction layer 142 can trigger the control engine 150 to trigger an alert to one or more user devices 102 for automated and/or manual operational team analysis of node operation.

In illustrative embodiments, the metrics data is pre-processed for feature selection before identifying correlations between various parameters. Feature selection is the process of selecting the attributes/parameters that can make the anomaly prediction more accurate and identifying the attributes/parameters that are irrelevant or can decrease accuracy. Feature correlation identifies relationships between multiple variables and attributes in a dataset, and indicates the presence of causal relationships or positive/negative correlations. Highly correlated features may be removed if they are redundant features, thereby reducing complexity, improving training and improving prediction performance. By measuring the behaviors and their relationships, the anomaly prediction layer 142 will predict when the state is normal and when it's anomalous.

The anomaly prediction layer 142 leverages an unsupervised learning approach and machine learning models to identify node anomalies to accurately predict outages. By predicting a potential outage before it occurs, the anomaly prediction layer 142 provides a basis for a decision by the control engine 150 (e.g., node assignment layer 152) to cause routing of database transactions to different nodes in a different data center, thus proactively eliminating the effects of an outage prior to a failure and enabling correction of problems with nodes without any service interruptions. As explained herein above, some of the nodes connected to the database management platform 110 operate as primary nodes (e.g., first plurality of leaf nodes 206-1) in a first data center (e.g., first data center 1 203-1), while other ones of the nodes connected to the database management platform 110 operate as secondary nodes (e.g., second plurality of leaf nodes 206-2) in a second data center (e.g., second data center 2 203-2). According to an embodiment, the primary nodes are first options to respond to database requests and/or queries, and the metrics collected from the primary nodes in connection with responding to the database queries and/or requests are analyzed by the anomaly prediction engine 140 to determine if there are any anomalies. If a primary node is designated as anomalous, database requests and/or queries are routed to a secondary node.

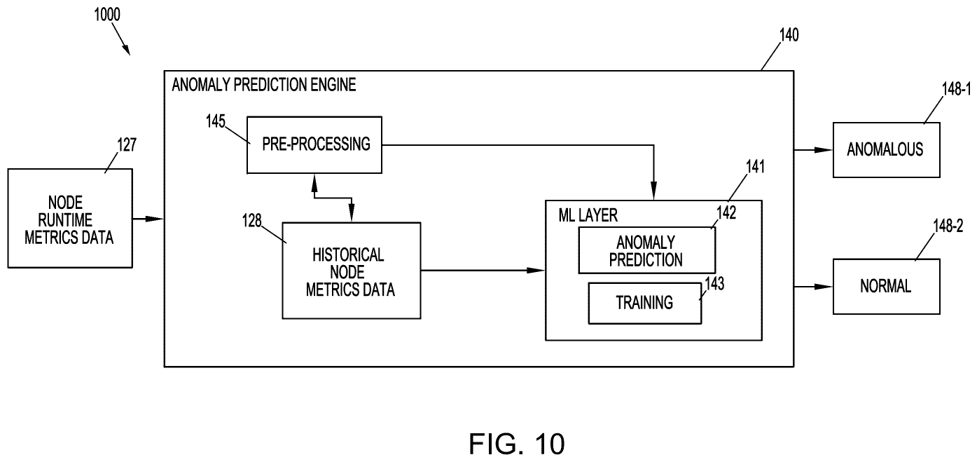

Referring to the operational flow 1000 in FIG. 10, a more detailed explanation of an embodiment of an anomaly prediction engine 140 is described. Node runtime metrics data 127 collected by, for example, a monitoring, collection and logging layer (e.g., monitoring, collection and logging layer 121) is input to the anomaly prediction engine 140. The anomaly prediction engine 140 illustrates a pre-processing component 145, which processes the incoming node runtime metrics data 127 and the historical node metrics data 128 for analysis by the machine learning (ML) layer 141. For example, the pre-processing component 145 performs the feature selection as described above and also removes any unwanted characters, punctuation, and stop words. As can be seen in FIG. 10, the anomaly prediction engine 140 analyzes the incoming node runtime metrics data 127 using the ML layer 141 comprising anomaly prediction and training layers 142 and 143. Based on the analysis, the anomaly prediction layer 142 determines, based on the node runtime metrics data 127, whether operation of a given node is anomalous 148-1 or normal 148-2.

The ML layer 141 leverages an unsupervised learning methodology using shallow or deep learning for outlier detection of infrastructure metrics that can be used as a precursor to a future outage. In an embodiment, the machine learning layer 141 implements multivariate anomaly detection using an isolation forest algorithm, which does not require labeled training data. In illustrative embodiments, the isolation forest algorithm uses a decision tree ensemble method with the assumption that anomalies are few and easy to isolate with few conditions, and identifies anomalies among the normal observations, by setting up a threshold value in a contamination parameter that can apply for real-time predictions. The isolation forest algorithm has the capacity to scale up to handle extremely large data sizes (e.g., terabytes) and high-dimensional problems with a large number of attributes, some of which may be irrelevant and potential noise. The isolation forest algorithm has relatively low linear time complexity and memory requirements, and prevents masking and swamping effects in anomaly detection. A masking effect is where a model predicts normal behavior when the behavior is anomalous. A swamping effect is where a model predicts anomalous behavior when the behavior is normal.

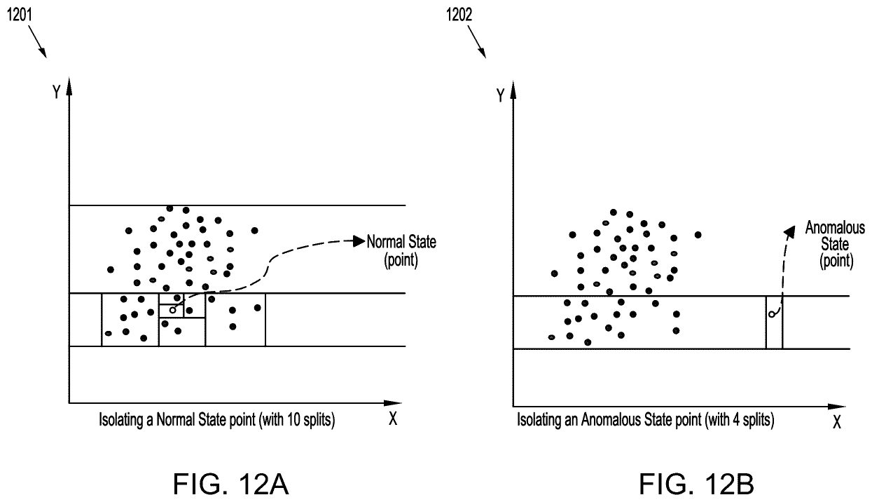

In illustrative embodiments, the machine learning model used by the ML layer 141 isolates an anomaly by creating decision trees over random attributes. This random partitioning produces significantly shorter paths since fewer instances of anomalies result in smaller partitions, and distinguishable attribute values are more likely to be separated in early partitioning. As a result, when a group (e.g., forest) of random trees collectively produces shorter path lengths for some particular points, then they are highly likely to be anomalies. A larger number of splits are required to isolate a normal point, while an anomaly can be isolated by a shorter number of splits. For example, referring to the plots 1201 and 1202 in FIGS. 12A and 12B, a normal state point is isolated with 10 splits and an anomalous state point is isolated with four splits. The splits are shown as horizontal and vertical lines in the plot of points. The number of splits determine the level at which the isolation occurred and is used by the anomaly prediction layer 142 to generate an anomaly score. The process is repeated multiple times, and the isolation level of each point is noted. Once an iteration is completed, the anomaly score of each point/instance suggests the likeliness of an anomaly. The score is a function of the average level at which the point is isolated. The top points/instances having an anomaly score exceeding a threshold are labeled as anomalies by the anomaly prediction layer 142. Alternatively, the ML layer 141 uses supervised learning models such as, for example, support vector machines (SVMs) or neural networks (e.g., artificial neural networks (ANNs)).

In illustrative embodiments, the monitoring, collection and logging layer 121 collects node runtime metrics data 127, and inputs the collected metrics to the anomaly prediction engine 140 to perform anomaly prediction. The machine learning model (e.g., isolation forest model) is trained using historical node metrics data 128. If the anomaly prediction layer 142 identifies parameter values deviating from typical values for a given node and/or having an anomaly score exceeding a threshold, the anomaly prediction layer 142 identifies operation of a given node as anomalous (e.g., anomalous 148-1). If the anomaly prediction layer 142 identifies parameter values consistent with typical values for a given node and/or having an anomaly score less than a threshold, the anomaly prediction layer 142 identifies operation of a given node as normal (e.g., normal 148-2).

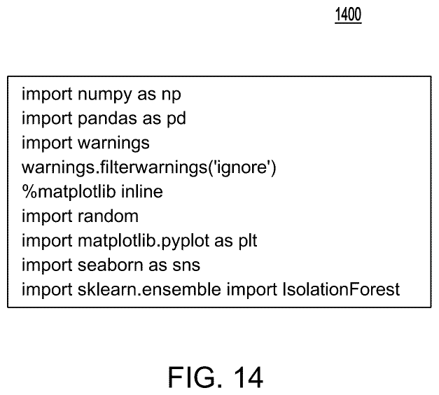

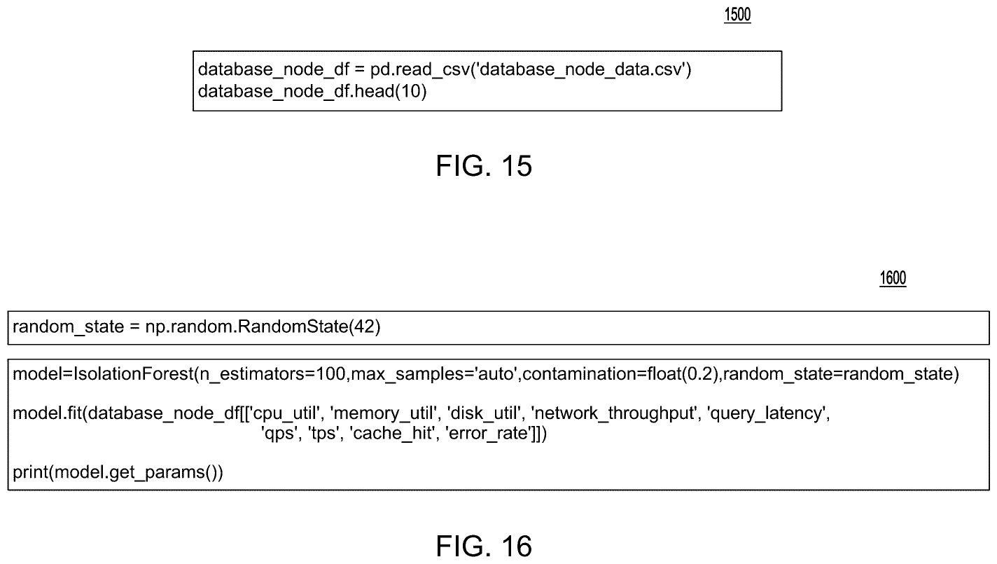

In connection with the operation of the anomaly prediction engine 140, FIG. 14 depicts example pseudocode 1400 for importation of libraries used to implement the anomaly prediction engine 140. For example, Python, ScikitLearn, Pandas and Numpy libraries can be used. FIG. 15 depicts example pseudocode 1500 for loading historical node metrics into a Pandas data frame for building training data.

FIG. 16 depicts example pseudocode 1600 for training an isolation forest model in an illustrative embodiment. For example, the isolation forest model is instantiated from ScikitLearn.ensemble package with some designated hyperparameters, such as, for example, a contamination parameter and a parameter for the number of estimators. Then the model is trained by passing the historical training data stored in the data frame. As can be seen in the pseudocode 1600, the historical training data includes the historical node metrics with the above-noted features (e.g., CPU, memory and disk utilization, network throughput, query latency, QPS, TPS, cache hit rate and error rate), but the embodiments are not necessarily limited thereto.

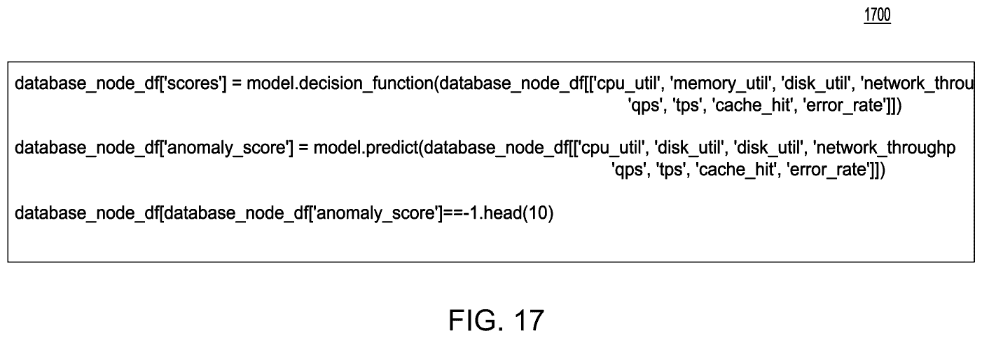

FIG. 17 depicts example pseudocode 1700 for computing anomaly scores using a model predict function. In one or more embodiments, the anomaly scores can be obtained from the model by using a model.predict( ) function in connection with the values of the node metrics. An anomaly score of −1 indicates a predicted anomaly and an anomaly score of 1 indicates a normal state prediction.

According to one or more embodiments, the database transactions data and metadata repository 122, node metrics repository 123 and other data repositories or databases referred to herein can be configured according to a relational database management system (RDBMS) (e.g., PostgreSQL). In some embodiments, the database transactions data and metadata repository 122, node metrics repository 123 and other data repositories or databases referred to herein are implemented using one or more storage systems or devices associated with the database management platform 110. In some embodiments, one or more of the storage systems utilized to implement the database transactions data and metadata repository 122, node metrics repository 123 and other data repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the database management platform 110, the data collection engine 120, replication class prediction engine 130, anomaly prediction engine 140 and/or control engine 150 in other embodiments can be implemented at least in part externally to the database management platform 110, for example, as stand-alone servers, sets of servers or other types of systems coupled to the network 104. For example, the data collection engine 120, replication class prediction engine 130, anomaly prediction engine 140 and/or control engine 150 may be provided as cloud services accessible by the database management platform 110.

The data collection engine 120, replication class prediction engine 130, anomaly prediction engine 140 and/or control engine 150 in the FIG. 1 embodiment are each assumed to be implemented using at least one processing device. Each such processing device generally comprises at least one processor and an associated memory, and implements one or more functional modules for controlling certain features of the data collection engine 120, replication class prediction engine 130, anomaly prediction engine 140 and/or control engine 150.

At least portions of the database management platform 110 and the elements thereof may be implemented at least in part in the form of software that is stored in memory and executed by a processor. The database management platform 110 and the elements thereof comprise further hardware and software required for running the database management platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the data collection engine 120, replication class prediction engine 130, anomaly prediction engine 140, control engine 150 and other elements of the database management platform 110 in the present embodiment are shown as part of the database management platform 110, at least a portion of the data collection engine 120, replication class prediction engine 130, anomaly prediction engine 140, control engine 150 and other elements of the database management platform 110 in other embodiments may be implemented on one or more other processing platforms that are accessible to the database management platform 110 over one or more networks. Such elements can each be implemented at least in part within another system element or at least in part utilizing one or more stand-alone elements coupled to the network 104.

It is assumed that the database management platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the data collection engine 120, replication class prediction engine 130, anomaly prediction engine 140, control engine 150 and other elements of the database management platform 110, and the elements thereof can each be implemented in the form of one or more LXCs running on one or more VMs. Other arrangements of one or more processing devices of a processing platform can be used to implement the data collection engine 120, replication class prediction engine 130, anomaly prediction engine 140 and control engine 150, as well as other elements of the database management platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the database management platform 110 to reside in different data centers. Numerous other distributed implementations of the database management platform 110 are possible.

Accordingly, one or each of the data collection engine 120, replication class prediction engine 130, anomaly prediction engine 140, control engine 150 and other elements of the database management platform 110 can each be implemented in a distributed manner so as to comprise a plurality of distributed elements implemented on respective ones of a plurality of compute nodes of the database management platform 110.

It is to be appreciated that these and other features of illustrative embodiments are presented by way of example only, and should not be construed as limiting in any way. Accordingly, different numbers, types and arrangements of system elements such as the data collection engine 120, replication class prediction engine 130, anomaly prediction engine 140, control engine 150 and other elements of the database management platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the database management platform can be offered to cloud infrastructure customers or other users as part of FaaS, CaaS and/or PaaS offerings.

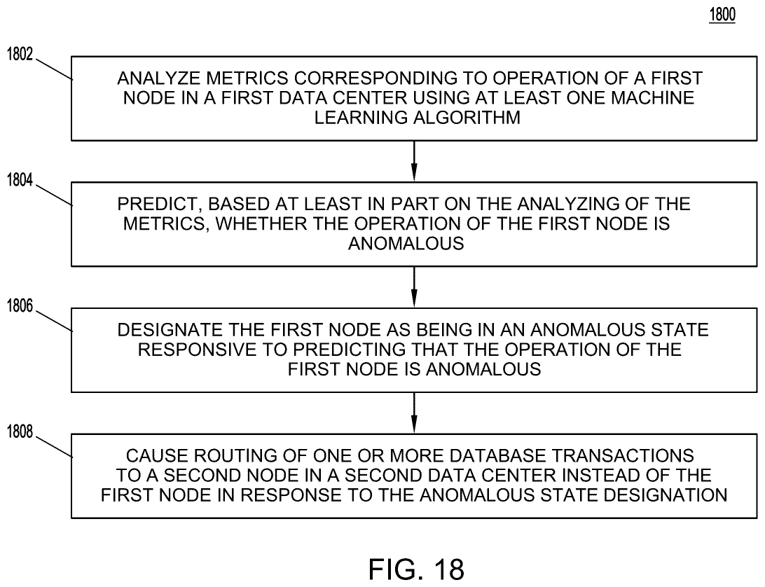

The operation of the information processing system 100 will now be described in further detail with reference to the flow diagram of FIG. 18. With reference to FIG. 18, a process 1800 for database management as shown includes steps 1802 through 1808, and is suitable for use in the system 100 but is more generally applicable to other types of information processing systems comprising a database management platform configured for proactive detection and resolution of data center issues.

In step 1802, metrics corresponding to operation of a first node in a first data center are analyzed using at least one machine learning algorithm. The metrics may comprise, for example, at least one of CPU utilization, memory utilization, disk utilization, network throughput, query latency, a number of processed queries per second, a number of processed database transactions per second, a cache hit rate and an error rate. The at least one machine learning algorithm may utilize an unsupervised learning technique to detect one or more outlier metrics of the metrics, and may comprise an isolation forest algorithm. The at least one machine learning algorithm may be trained with training data comprising historical metrics data.

In step 1804, based at least in part on the analyzing of the metrics, a prediction is made whether the operation of the first node is anomalous. In step 1806, the first node is designated as being in an anomalous state responsive to predicting that the operation of the first node is anomalous.

Step 1808 includes causing routing of one or more database transactions to a second node in a second data center instead of the first node in response to the anomalous state designation. In an illustrative embodiment, the first data center comprises a first cluster of nodes in a first geographic location and the second data center comprises a second cluster of nodes in a second geographic location. Each of the first data center and the second data center may comprise at least one of an in-memory database and a graph database. The designating of the first node as being in the anomalous state and the routing of the one or more database transactions to the second node in the second data center can be performed when the first node is operational (e.g., prior to node failure).

In an illustrative embodiment, the process further includes analyzing at least one of data and metadata corresponding to the one or more database transactions using at least an additional machine learning algorithm, and predicting, based at least in part on the analyzing of at least one of the data and the metadata, a class of replication to apply between a first cluster of nodes in the first data center and a second cluster of nodes in the second data center in connection with the one or more database transactions. The class of replication may comprise synchronous replication or asynchronous replication. The data and/or the metadata identify at least one of database transaction type, a level of data criticality, a level of data urgency, database transaction frequency, a latency tolerance and a replication delay tolerance. The additional machine learning algorithm may utilize a plurality of decision trees, wherein the plurality of decision trees are respectively trained with different portions of at least one of historical data and historical metadata corresponding to a plurality of database transactions. The selection of the class of replication to apply between the first cluster of nodes and the second cluster of nodes corresponds to a result produced by a majority of the plurality of decision trees.

It is to be appreciated that the FIG. 18 process and other features and functionality described above can be adapted for use with other types of information systems configured to execute database management services in a database management platform or other type of platform.

The particular processing operations and other system functionality described in conjunction with the flow diagram of FIG. 18 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 18 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a database management platform as disclosed herein can provide a number of significant advantages relative to conventional arrangements. For example, the database management platform uses machine learning to proactively predict data center node outages to minimize impact on databases (e.g., in-memory and graph databases) relying on the data centers. The embodiments advantageously leverage an unsupervised learning approach and machine learning models to detect node anomalies and accurately predict node outages. By predicting an upcoming outage before it occurs, the embodiments facilitate routing of database transactions to different nodes in different data centers and eliminate the effects of outages by addressing them prior to their actual occurrence.

Many databases currently implement a reactive approach of waiting for a node to fail before switching to one of the secondary nodes, which has several disadvantages, including increased down time, user experience issues, potential data integrity loss and/or data loss due to lack of data synchronization at the time of outages, and system stability issues that may cause potential cascading effects on the entire system while recovering from an unexpected outage. Traditional solutions are also disadvantaged by manual intervention needed to activate traditional DR, the time required for manual failover steps and a complex database platform to manage.

Illustrative embodiments described herein advantageously solve the noted obstacles by locating the HA servers to another data center to stretch the cluster across a network (e.g., WAN). Stretching the cluster between separate data centers serves HA and DR scenarios at little or no extra cost. In addition, this innovative framework leverages predictive monitoring of system resources and machine learning-based anomaly detection algorithms to identify impending failures and take preemptive measures to switch to a secondary node seamlessly before the primary node fails, thereby minimizing downtime, preventing data loss and increasing system stability.

As an additional advantage, the illustrative embodiments classify database transactions into one of two classes and select the appropriate replication approach. An intelligent machine learning-based classifier categorizes the database transactions for asynchronous or synchronous replication based on multi-dimensional features.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the database management platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a database management platform in illustrative embodiments. These and other cloud-based systems in illustrative embodiments can include object stores.

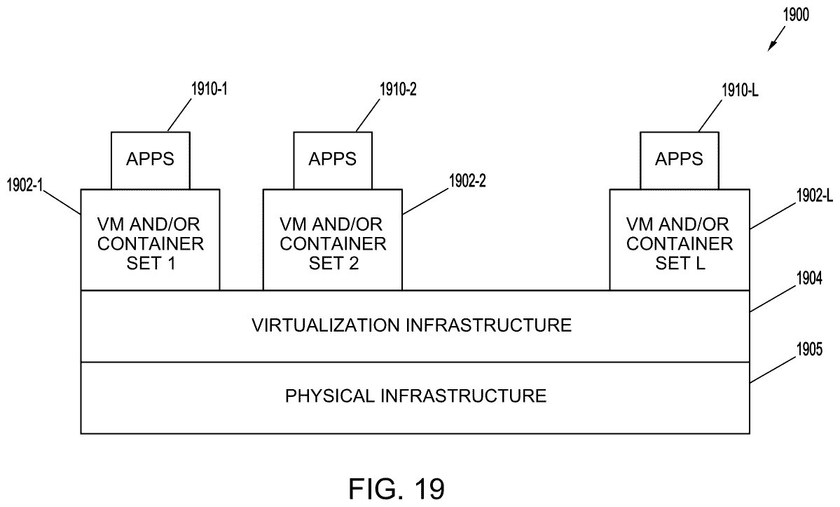

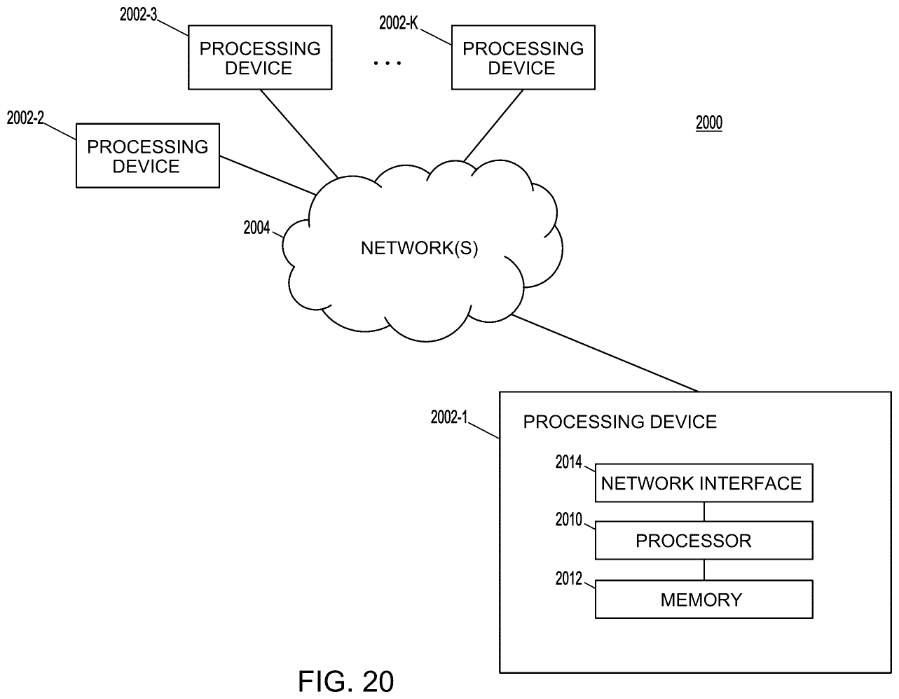

Illustrative embodiments of processing platforms will now be described in greater detail with reference to FIGS. 19 and 20. Although described in the context of system 100, these platforms may also be used to implement at least portions of other information processing systems in other embodiments.

FIG. 19 shows an example processing platform comprising cloud infrastructure 1900. The cloud infrastructure 1900 comprises a combination of physical and virtual processing resources that may be utilized to implement at least a portion of the information processing system 100. The cloud infrastructure 1900 comprises multiple virtual machines (VMs) and/or container sets 1902-1, 1902-2, . . . 1902-L implemented using virtualization infrastructure 1904. The virtualization infrastructure 1904 runs on physical infrastructure 1905, and illustratively comprises one or more hypervisors and/or operating system level virtualization infrastructure. The operating system level virtualization infrastructure illustratively comprises kernel control groups of a Linux operating system or other type of operating system.

The cloud infrastructure 1900 further comprises sets of applications 1910-1, 1910-2, . . . 1910-L running on respective ones of the VMs/container sets 1902-1, 1902-2, . . . 1902-L under the control of the virtualization infrastructure 1904. The VMs/container sets 1902 may comprise respective VMs, respective sets of one or more containers, or respective sets of one or more containers running in VMs.

In some implementations of the FIG. 19 embodiment, the VMs/container sets 1902 comprise respective VMs implemented using virtualization infrastructure 1904 that comprises at least one hypervisor. A hypervisor platform may be used to implement a hypervisor within the virtualization infrastructure 1904, where the hypervisor platform has an associated virtual infrastructure management system. The underlying physical machines may comprise one or more distributed processing platforms that include one or more storage systems.

In other implementations of the FIG. 19 embodiment, the VMs/container sets 1902 comprise respective containers implemented using virtualization infrastructure 1904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1900 shown in FIG. 19 may represent at least a portion of one processing platform. Another example of such a processing platform is processing platform 2000 shown in FIG. 20.

The processing platform 2000 in this embodiment comprises a portion of system 100 and includes a plurality of processing devices, denoted 2002-1, 2002-2, 2002-3, . . . 2002-K, which communicate with one another over a network 2004.

The network 2004 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 2002-1 in the processing platform 2000 comprises a processor 2010 coupled to a memory 2012. The processor 2010 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 2012 may comprise random access memory (RAM), read-only memory (ROM), flash memory or other types of memory, in any combination. The memory 2012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 2002-1 is network interface circuitry 2014, which is used to interface the processing device with the network 2004 and other system components, and may comprise conventional transceivers.

The other processing devices 2002 of the processing platform 2000 are assumed to be configured in a manner similar to that shown for processing device 2002-1 in the figure.

Again, the particular processing platform 2000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the database management platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and database management platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. A method, comprising:
distributing data of a database system over a first cluster of nodes of a first data center and a second cluster of nodes of a second data center;
analyzing metrics corresponding to operation of a first node in the first cluster of nodes of the first data center using at least one machine learning algorithm;
predicting, based at least in part on the analyzing of the metrics, whether the operation of the first node is anomalous with a potential of the first node to fail;
designating the first node as being in an anomalous state responsive to predicting that the operation of the first node is anomalous with the potential of the first node to fail; and
prior to a failure of the first node, and in response to the anomalous state designation of the first node:
assigning one or more second nodes of the second cluster of nodes of the second data center to be utilized in place of the first node to perform database transactions; and
causing a routing of one or more database transactions to the one or more second nodes in the second data center instead of the first node;
wherein the steps of the method are executed by a processing device operatively coupled to a memory.

2. The method of claim 1, further comprising:
analyzing at least one of data and metadata corresponding to the one or more database transactions using at least an additional machine learning algorithm; and
predicting, based at least in part on the analyzing of at least one of the data and the metadata, a class of replication to apply between the first cluster of nodes in the first data center and the second cluster of nodes in the second data center in connection with the one or more database transactions.

3. The method of claim 2, wherein the class of replication comprises one of synchronous replication and asynchronous replication.

4. The method of claim 2, wherein at least one of the data and the metadata identify at least one of database transaction type, a level of data criticality, a level of data urgency, database transaction frequency, a latency tolerance and a replication delay tolerance.

5. The method of claim 2, wherein:
the additional machine learning algorithm comprises a plurality of decision trees;
the plurality of decision trees are respectively trained with different portions of at least one of historical data and historical metadata corresponding to a plurality of database transactions; and
the class of replication to apply between the first cluster of nodes and the second cluster of nodes corresponds to a result produced by a majority of the plurality of decision trees.

6. The method of claim 1, wherein the first cluster of nodes of the first data center are in a first geographic location and the second cluster of nodes of the second data center are in a second geographic location.

7. The method of claim 1, wherein the database system comprises at least one of an in-memory database and a graph database.

8. The method of claim 1, wherein the metrics comprise at least one of central processing unit utilization, memory utilization, disk utilization, network throughput, query latency, a number of processed queries per second, a number of processed database transactions per second, a cache hit rate and an error rate.

9. The method of claim 1, wherein the at least one machine learning algorithm utilizes an unsupervised learning technique to detect one or more outlier metrics of the metrics.

10. The method of claim 9, wherein the at least one machine learning algorithm comprises an isolation forest algorithm.

11. The method of claim 9, further comprising training the at least one machine learning algorithm with training data comprising historical metrics data.

12. (canceled)

13. An apparatus comprising:
at least one processing device that is operatively coupled to a memory, wherein the memory stores program instructions that are executed by the at least one processing device to instantiate a database management platform which operates to:
distribute data of a database system over a first cluster of nodes of a first data center and a second cluster of nodes of a second data center;
analyze metrics corresponding to operation of a first node in the first cluster of nodes of the first data center using at least one machine learning algorithm;
predict, based at least in part on the analyzing of the metrics, whether the operation of the first node is anomalous with a potential of the first node to fail;
designate the first node as being in an anomalous state responsive to predicting that the operation of the first node is anomalous with the potential of the first node to fail; and
prior to a failure of the first node, and in response to the anomalous state designation of the first node:
assign one or more second nodes of the second cluster of nodes of the second data center to be utilized in place of the first node to perform database transactions; and
cause a routing of one or more database transactions to the one or more second nodes in the second data center instead of the first node.

14. The apparatus of claim 13, wherein the database management platform further operates to:
analyze at least one of data and metadata corresponding to the one or more database transactions using at least an additional machine learning algorithm; and
predict, based at least in part on the analyzing of at least one of the data and the metadata, a class of replication to apply between the first cluster of nodes in the first data center and the second cluster of nodes in the second data center in connection with the one or more database transactions.

15. The apparatus of claim 14, wherein the class of replication comprises one of synchronous replication and asynchronous replication.

16. The apparatus of claim 14, wherein the first cluster of nodes of the first data center are in a first geographic location and the second cluster of nodes of the second data center are in a second geographic location.

17. An article of manufacture comprising a non-transitory processor-readable storage medium having stored therein program code of one or more software programs, wherein the program code when executed by at least one processing device causes said at least one processing device to instantiate a database management platform which operates to perform the steps of:
distributing data of a database system over a first cluster of nodes of a first data center and a second cluster of nodes of a second data center;
analyzing metrics corresponding to operation of a first node in the first cluster of nodes of the first data center using at least one machine learning algorithm;
predicting, based at least in part on the analyzing of the metrics, whether the operation of the first node is anomalous with a potential of the first node to fail;
designating the first node as being in an anomalous state responsive to predicting that the operation of the first node is anomalous with the potential of the first node to fail; and
prior to a failure of the first node, and in response to the anomalous state designation of the first node:
assigning one or more second nodes of the second cluster of nodes of the second data center to be utilized in place of the first node to perform database transactions; and
causing a routing of one or more database transactions to the one or more second nodes in the second data center instead of the first node.

18. The article of manufacture of claim 17, wherein the instantiated database management platform further performs the steps of:
analyzing at least one of data and metadata corresponding to the one or more database transactions using at least an additional machine learning algorithm; and
predicting, based at least in part on the analyzing of at least one of the data and the metadata, a class of replication to apply between the first cluster of nodes in the first data center and the second cluster of nodes in the second data center in connection with the one or more database transactions.

19. The article of manufacture of claim 18, wherein the class of replication comprises one of synchronous replication and asynchronous replication.

20. The article of manufacture of claim 17, wherein the first cluster of nodes of the first data center are in a first geographic location and the second cluster of nodes of the second data center are in a second geographic location.

21. The article of manufacture of claim 18, wherein at least one of the data and the metadata identify at least one of database transaction type, a level of data criticality, a level of data urgency, database transaction frequency, a latency tolerance and a replication delay tolerance.
